(19) United States
(12) Patent Application Publication
(10) Pub. No.: US 2011/0067399 A1
(43) Pub. Date: Mar. 24, 2011

(54) GEOTHERMAL POWER SYSTEM

(75) Inventors: William H. Rogers, North Vancouver (CA); Michael J. Smith, Calgary (CA)

(73) Assignee: 7238703 CANADA INC., North Vancouver (CA)

(21) Appl. No.: 12/564,796

(22) Filed: Sep. 22, 2009

(51) Int. Cl. F03G 7/00; E21B 43/25

(52) U.S. Cl. 60/641.2; 166/306

(57) ABSTRACT

A geothermal system in deep, hot, dry rock has closed loop circulation, in which the water and steam circulating in the system are protected from any direct contact with the base rock. The system has a single L-shaped bore with a casing that lines the wellbore and has a sealed bottom end. A tubing within the casing has an open bottom end. Water or other liquid or gas is injected under pressure into the casing in the space between the casing and the tubing and is heated by the deep hot rock strata, creating heated liquid or gas which flows into the tubing through its open bottom end and is returned to the surface for use for heating, or in a power plant, or other applications. In a reverse configuration, the working fluid is injected into the tubing and is returned via the space between the casing and the tubing.

### BACKGROUND OF THE INVENTION

The invention pertains to geothermal systems for the generation of electricity or heat, in particular geothermal systems that extract heat from deep hot dry rock.

Geothermal systems utilize the high temperatures available at substantial depth underground generally to heat water to produce steam. Where the rock strata are hot and dry, i.e. without naturally-occurring hot aquifers, the system that is normally employed, referred to as an enhanced geothermal system, involves drilling two boreholes and fracturing the rock between them at depth. Water pumped down one borehole travels through the hot, fractured rock to produce heated water, and the heated water is removed from the other borehole for use in a power plant or for heating. Because the water and steam are in direct contact with the base rock, they generally become contaminated with undesirable or toxic gases and chemicals, including hydrogen sulfide, mercury and arsenic. Emission-controlling systems are required for the gases, and the steam and/or the water condensed from the steam has to be treated to remove the contaminants. This increases the capital and operating costs of the geothermal system. Although the contamination problem has been recognized in the prior art, e.g. U.S. Pat. No. 6,301,894 Halff, a workable system which avoids the problem has not been previously achieved.

### SUMMARY OF THE INVENTION

The invention provides a geothermal system having closed loop circulation, in which the working fluid media circulating in the system, e.g. water and steam, are always separated from any direct contact with the base rock. The hot water or steam brought up to or near the ground surface is therefore free of base rock contaminants, avoiding the need to clean it. The geothermal system of the invention has a single wellbore, sealed from the surrounding rock by a casing. Water (or other liquid or gaseous working medium) is fed into the piping installed in the borehole to be heated and hot water or steam is returned to the surface for use, all within a closed circulation system whereby the water and steam are kept out of all direct contact with the base rock.

### BRIEF DESCRIPTION OF THE DRAWINGS

FIG. 1 is a schematic drawing, not to scale, of a single pod geothermal system according to the invention.

FIG. 2 is a schematic drawing, not to scale, of a cross-sectional view through the wellbore near the ground surface.

FIG. 3 is a schematic drawing, not to scale, of a detailed sectional view of the bottom end of the wellbore.

### DETAILED DESCRIPTION OF THE PREFERRED EMBODIMENT

A wellbore 20 extends from the ground surface 22 to hot rock strata 24 at a depth underground having sufficient heat for use in the system, for example a depth in the range of 15,000 to 28,000 feet. It could require more or less depth depending on the heat desired and the local lithology. The wellbore 20 comprises a first section 26 extending generally vertically to the desired depth or strata and a second section 28 extending generally horizontally within that hot rock strata 24. The wellbore 20 is thus approximately L-shaped. The second section 28 has a length sufficient to allow contact time for heating of the water injected into the piping in the wellbore to a desired temperature, for example a temperature in the order of 150° C. to 200° C.

The wellbore is lined throughout with a casing 30 comprising steel piping. The bottom end of the casing, at the end of the borehole, is closed with a permanent plug 32. The casing and plug provide a sealed system whereby the interior of the casing is completely sealed from the surrounding rock.

A second pipe, referred to herein as “tubing,” 34 is inserted inside the casing from the ground surface through both sections of the wellbore, terminating in an open end 36, which is relatively near the casing plug 32. The tubing 34 is a steel pipe that has an outer diameter that is smaller than the inner diameter of the casing, such that there is a space 38 between the tubing and the casing. Since the bottom end 36 of the tubing 34 is open, heated water in the space 38 can flow freely into the tubing.

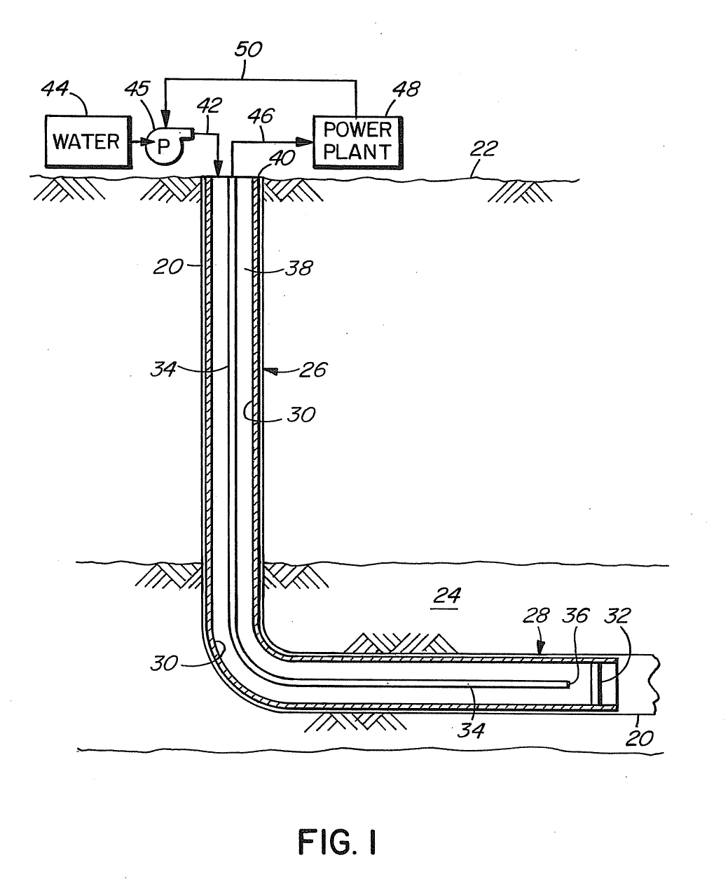

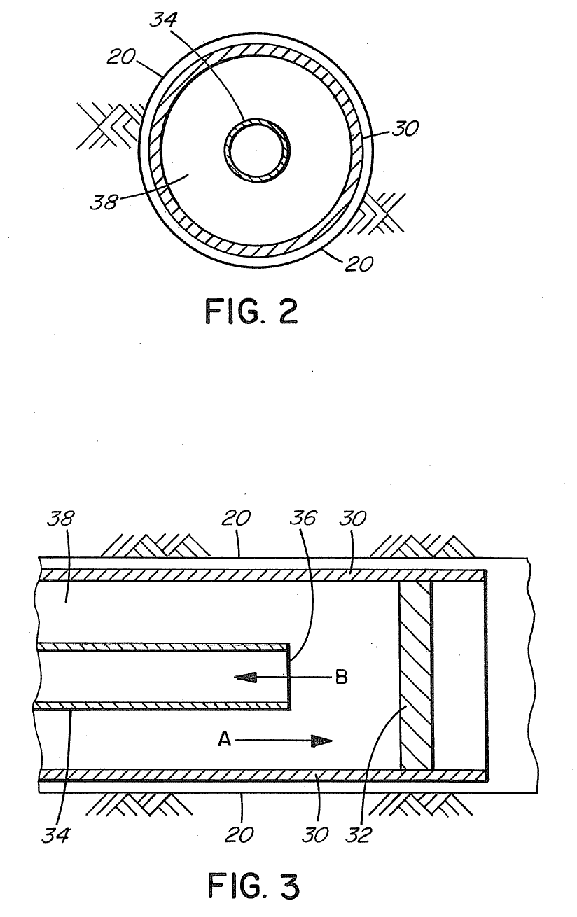

In the vicinity of the wellhead 40, apparatus is provided for feeding cooler water into the casing to be heated and for receiving heated water from the tubing and using it to generate electricity or for heating, or other uses. In the preferred embodiment, water is fed into the casing through the annular space 38 and heated water is received at the ground surface from the tubing 34. As shown schematically in FIG. 1, the space 38 within the casing is connected by a conduit 42 to a water source 44 and pump 45, whereby water is injected under pressure into the space 38. The tubing 34 is connected by a conduit 46 to a power plant 48. The power plant may be any of several general designs of generating plants for converting steam or hot water energy into electrical energy. Examples include binary-cycle heat exchanger power plants, dry steam plants and flash steam plants. The power plant may be connected to an electric power distribution grid.

The residual steam or condensed water from the power plant is returned by a loop 50 to the pump 45, for reinjection into the casing. Water treatment apparatus (not shown) may be provided in the water delivery circuit, to control rusting and scaling within the apparatus.

Where the water is reused in the system, as in the preferred embodiment, only minimal make-up water need be added from the water source to make up for losses. Alternatively, part or all of the residual steam or condensed water from the power plant may be put to secondary uses, such as heating facilities or processes.

In use, water is pumped down the casing in the space 38 by the pump 45. Within the horizontal section 28 of the wellbore, the water is heated by the surrounding hot rock strata by means of conduction through the steel casing, forming steam (which may remain in the form of superheated water while under pressure in the casing and tubing, until it reaches the ground surface). The heated water flows into the tubing 34 through its open end 36, as indicated by the arrows A and B in FIG. 3, all without coming into any direct contact with the surrounding rock, and returns to the ground surface where it is directed to the power plant (or is put to another use).

The geothermal well can be constructed according to techniques used for other purposes in the oil and gas industry. The bore 20 is drilled, using directional drilling for the horizontal section, and the steel casing 30 is inserted to the end of the bore and closed with the plug 32. The tubing 34 is then inserted. The components at the top of the bore are cemented in place to withstand the pressure on the system. The wellhead and related safety and connection gear and methods are in accordance with applicable requirements and professional assessments of potential risks at the site and the end use(s) of the heated medium.

Various modifications within the scope of the invention will be apparent to those skilled in the art. For example, the system can be configured with the flow directions in the casing and the tubing reversed, such that water is inserted into the tubing and heated water is returned through the space 38 between casing and tubing. The first section 26 of the wellbore need not be substantially vertical, nor the second section 28 substantially horizontal; they can be arranged at other angles, depending upon the properties of a particular site. The working fluid medium does not have to be water and can comprise other liquids or gases that can transport subterranean heat to the surface. The geothermal system can be used for applications other than the generation of electricity, for example as a source of heat for various purposes, e.g. for industrial processes, such as oilsands or heavy oil extraction, or for heating buildings. The casing can be made of heat-conductive materials other than steel. There may optionally be cementing of the space between the casing and the borehole for all or part of the casing length. Cementing may optionally have extra conductive properties relative to standard oilfield cement. The geothermal system can be scaled up for greater heat production for larger end use requirements by providing two or more wellbores as aforesaid having respective first sections 26 in relatively close proximity to each other and respective second sections 28 which radiate in different directions to each other, preferably in the same hot rock strata. This configuration allows the wellheads to be in proximity to each other and be used to feed a single large scale integrated use at the surface. The scope of the invention is defined by the claims that follow.

What is claimed is:

1. A geothermal system comprising:
(a) a wellbore comprising a first section extending from a ground surface to selected hot rock strata and a second section extending at an angle to the first section generally within the hot rock strata;
(b) a casing which sealingly lines the wellbore and has a sealed end in the second section of the casing;
(c) a tubing within the casing extending through the first section and the second section of the wellbore and having an open end within the casing in the second section of the wellbore, the tubing having an outer diameter smaller than the inner diameter of the casing, defining a space between the outer surface of the tubing and the inner surface of the casing;
(d) an apparatus for injecting a working fluid into the space between the casing and the tubing; and
(e) an apparatus for receiving heated working fluid from the tubing.

2. A geothermal system comprising:
(a) a wellbore comprising a first section extending from a ground surface to selected hot rock strata and a second section extending at an angle to the first section generally within the hot rock strata;
(b) a casing which sealingly lines the wellbore and has a sealed end in the second section of the casing;
(c) a tubing within the casing extending through the first section and the second section of the wellbore and having an open end within the casing in the second section of the wellbore, the tubing having an outer diameter smaller than the inner diameter of the casing, defining a space between the outer surface of the tubing and the inner surface of the casing;
(d) an apparatus for injecting a working fluid into the tubing; and
(e) an apparatus for receiving heated working fluid from the space between the casing and the tubing.

3. A system according to claim 1, wherein the first section is substantially vertical and the second section is substantially horizontal.

4. A system according to claim 1, in combination with further apparatus comprising a power plant for converting the heated fluid into electricity.

5. A system according to claim 2, in combination with further apparatus comprising a power plant for converting the heated fluid into electricity.

6. A system according to claim 3, in combination with further apparatus comprising a power plant for converting the heated fluid into electricity.

7. A system according to claim 1, in combination with further apparatus for converting the heated fluid into heat or power for an industrial process or the heating of buildings.

8. A system according to claim 2, in combination with further apparatus for converting the heated fluid into heat or power for an industrial process or the heating of buildings.

9. A system according to claim 1, in combination with further apparatus for converting the heated fluid into heat for use in another application.

10. A system according to claim 2, in combination with further apparatus for converting the heated fluid into heat for use in another application.

11. A geothermal system comprising two or more geothermal systems according to claim 1, wherein the respective second sections of the wellbores radiate in different directions to each other and the respective first sections of the wellbores are in sufficient proximity to each other for the combined heated working fluid to be used for a larger or integrated use.

12. A geothermal system comprising two or more geothermal systems according to claim 2, wherein the respective second sections of the wellbores radiate in different directions to each other and the respective first sections of the wellbores are in sufficient proximity to each other for the combined heated working fluid to be used for a larger or integrated use.

13. A geothermal system according to claim 11, wherein the respective second sections of the wellbore radiate in different directions to each other within the same hot rock strata.

14. A system according to claim 1, wherein the working fluid comprises water.

15. A system according to claim 2, wherein the working fluid comprises water.

16. A system according to claim 11, wherein the working fluid comprises water.

17. A system according to claim 1, wherein the working fluid comprises a liquid.

18. A system according to claim 1, wherein the working fluid comprises a gas.

19. A system according to claim 1, wherein the casing is cemented to the wellbore sides along part or all of the length of the casing.

20. A system according to claim 2, wherein the casing is cemented to the wellbore sides along part or all of the length of the casing.
